(19) United States
(12) Patent Application Publication
(10) Pub. No.: US 2004/0047457 A1
(43) Pub. Date: Mar. 11, 2004

(54) Dialing apparatus for international prepaid phone card

(75) Inventor: Chung-Cheng Wang, Taipei (TW)

Correspondence Address: Mr. Charles W. Fallow, SHOEMAKER AND MATTARE, LTD., Crystal Plaza Bldg.I, Suite 1203, 2001 Jefferson Davis Highway, Arlington, VA, 22202-0286, US

(73) Assignee: Sweetone Science Technology Inc., Taipei (TW)

(21) Appl. No.: 10/437,289

(22) Filed: May 14, 2003

(30) Foreign Application Priority Data
Aug. 19, 2002 (TW) 091212819

(51) Int. Cl. H04M 15/00

(52) U.S. Cl. 379/114.15; 379/114.2

(57) ABSTRACT

A dialing apparatus for international prepaid phone card, the user of which may more rapidly, more conveniently and more accurately place international phone calls. The dialing apparatus is suitable for working with a telephone apparatus so that the user may place phone calls by charging the international prepaid phone card via the telephone apparatus. The dialing apparatus comprises of: an integrated circuit, a keyboard unit connected with the integrated circuit, a memory unit to store the necessary configuration information of the international prepaid phone card and at lease a set of telephone number that the user wishes to call, and a speaker connected with the integrated circuit. While the user wishes to place international phone calls, it is only necessary to press a few keys on the keyboard unit. The integrated circuit will then read the necessary configuration information of the international prepaid phone card and the phone number that the user wishes to call pre-stored in the memory unit. Based on the information read, the integrated circuit sends the corresponding dialing voice signal to the speak via the DTMF (Dual Tone Multiple Frequency) signal processing function so that the dialing process is completed by the telephone apparatus according to the voice signal from the speaker. A dialing apparatus for international prepaid phone card, the user of which may more rapidly, more conveniently and more accurately place international phone calls. The dialing apparatus is suitable for working with a telephone apparatus so that the user may place phone calls by charging the international prepaid phone card via the telephone apparatus. The dialing apparatus comprises of: an integrated circuit, a keyboard unit connected with the integrated circuit, a memory unit to store the necessary configuration information of the international prepaid phone card and at lease a set of telephone number that the user wishes to call, and a speaker connected with the integrated circuit. While the user wishes to place international phone calls, it is only necessary to press a few keys on the keyboard unit. The integrated circuit will then read the necessary configuration information of the international prepaid phone card and the phone number that the user wishes to call pre-stored in the memory unit. Based on the information read, the integrated circuit sends the corresponding dialing voice signal to the speak via the DTMF (Dual Tone Multiple Frequency) signal processing function so that the dialing process is completed by the telephone apparatus according to the voice signal from the speaker.

### BACKGROUND OF THE INVENTION

1. Field of the Invention

This invention relates generally to a telephone dialing apparatus, and, more particularly, to a telephone dialing apparatus that can place international phone calls by charging an international prepaid phone card.

2. Background of the Invention

Due to the advancement of transportation and communication technologies, the spatial separation is no longer affecting the efficiency of communication between people, societies and nations. On the other hand, it largely increased the frequency of mutual activities and communications. Consequently, the development of a business or the job and life of an individual is no longer restricted to confining in one country, but very often, extended to other countries.

Business or individual can immediately interact and communicate with the other side of the world via telephone calls. International phone calls indeed provide a mean for immigrants, foreign students and business travelers to get contact with their families, relatives, friends or colleagues. However, the communication fees of international phone calls are very high, thus, it often prevents the users from talking as much as they want.

Accordingly, the international prepaid phone cards with lower communication fees was invented, the user can easily place international phone calls by following the instructions on the phone card. First, dial the tolls free number of the local company of the prepaid phone card. After the phone call is connected, the company of the prepaid phone card will request the user to select a preferred language code. Usually, the language code contains only one digit, for example, enter “1” if you prefer English. This will determine the kind of language that the user will later hear from the telephone system. Next, in order to verify the validity of the international prepaid phone card, the company of the prepaid phone card will request the user to enter the card number on the phone card. After the company of the prepaid phone card has verified the validity of the card number, it will request the user to dial the phone number that the user wishes to call. If the phone number that the user is calling is not busy, after a while, this call can be connected.

The process of dialing phone calls via international prepaid phone cards is very tedious. This is resulted from the many steps of conversation and confirmation process. Also, the reaction time of each step is not the same. The phone number that the user wishes to call will not be connected provided that the user has pressed a wrong key during the dialing process. Therefore, the well-known dialing method of the international prepaid phone cards is very inconvenient and time consuming.

For this reason, the present invention is intended to solve the problem of how to provide an dialing apparatus which can automatically execute the well-known dialing process of international prepaid phone cards. This apparatus can thus provide the end user with a convenient, time saving and accurate dialing method for international prepaid phone cards and need not to worry about pressing the wrong key while dialing the phone card number or the phone number.

### SUMMARY OF THE INVENTION

Due to the disadvantage of the well-known technology, the primary purpose of the present invention is to provide a dialing apparatus for international prepaid phone cards which can provide the user of the phone card a faster, more convenient and more accurate process of placing international phone calls.

The present invention of a dialing apparatus for international prepaid phone cards, which is suitable for working with a telephone apparatus, can let the user place phone calls by charging the international prepaid phone cards via dialing the telephone apparatus. The dialing apparatus includes: an integrated circuit, and a keyboard unit that is connected with the integrated circuit for users to enter the necessary information of the international prepaid phone cards and at least one set of phone number and stored these information in the memory unit. While the user is placing international calls, the user only needs to press a few keys on the keyboard unit. The dialing process is performed automatically by the integrated circuit based on the information of the prepaid phone card and the phone number that the user wishes to call pre-stored in the memory unit. Therefore, by means of the present invention of a dialing apparatus, the user can rapidly and accurately complete the dialing process without entering a long string of necessary configuration information of the international prepaid phone card and the contact phone number.

### BRIEF DESCRIPTION OF THE DRAWINGS

The technical contents and embodiments of the present invention are illustratively disclosed in detail by the drawings accompanying the description. The contents of these drawings are briefly described as the following:

FIG. 1 is a block diagram, wherein the block diagram of the structure of the present invention of a dialing apparatus for the international prepaid phone cards working with a telephone apparatus is shown.

FIG. 2 is a block diagram, wherein the block diagram of the basic structure of the dialing apparatus for the international prepaid phone cards in FIG. 1 is shown.

FIG. 3 is a flow diagram, which shows the configuration process of entering the necessary information into the dialing apparatus by the user while using the present invention of a dialing apparatus for the international prepaid phone cards for the first time.

FIG. 4 is a data structure diagram, which shows the data stored by the memory unit of the present invention of a dialing apparatus for the international prepaid phone cards.

### EMBODIMENTS OF THE INVENTION

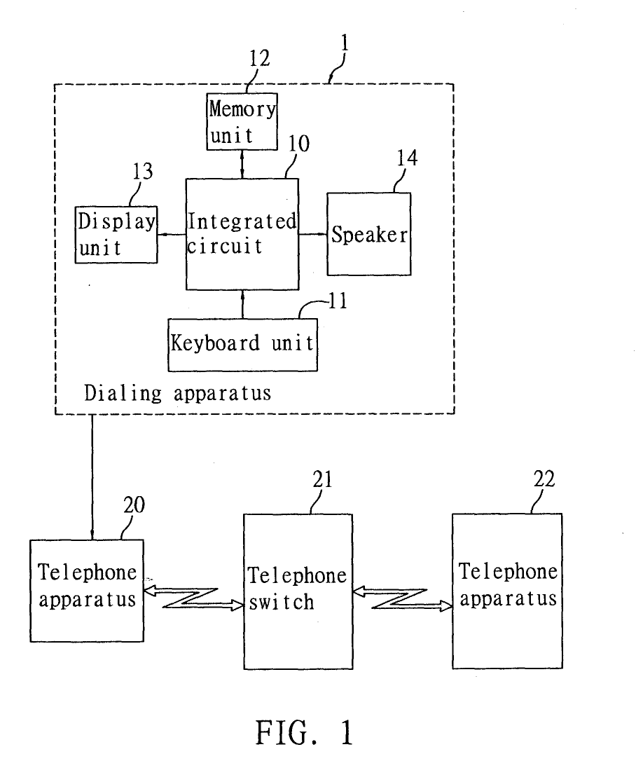

In FIG. 1, it shows the block diagram of the structure of the present invention of a dialing apparatus for international prepaid phone cards 1 working with the telephone apparatus 20. In the drawing, the telephone apparatus 20 indicates the telephone used by the local user, the telephone apparatus 22 is the telephone used by the remote user. These telephone apparatus are normal telephones used at home or in hotel rooms. The telephone apparatus 20 of the local user are connected with the telephone apparatus 22 of the remote user via the telephone switch 21. Since the telephone apparatus (20, 22) and the telephone switch 21 are the necessary equipment of the normal telephone communication process, the detailed descriptions of their function and internal structure are thus neglected.

In the drawing, the speaker 14 should be placed touching the transmitter of the local telephone apparatus 20 (not shown) while using the present invention of a dialing apparatus 1. Since the dialing apparatus 1 supports the function of processing DTMF (Dual Tone Multiple Frequency) signals and provides a mean for storing the basic configuration information, including, at least, the tolls free number of the company of the prepaid phone card, the preferred language code, and the card number of the international prepaid phone card, of the international prepaid phone cards, thus, the user is only required to operate the auto-dial function key and the number key representing the international phone number that the user wishes to call provided by the dialing apparatus 1 to dial any international phone number using the international prepaid phone card. Based on the pre-stored basic information and international phone number that the user wishes to call, the present invention of a dialing apparatus 1 produces a corresponding DTMF signal and transforms the DTMF signal to dial tone through the speaker 14 built-in in the dialing apparatus 1. According to the dial tone signal received from the dialing apparatus 1, the dialing process is performed on the telephone apparatus 20 of the user.

Therefore, the present invention of a dialing apparatus 1 provides a Speed Dialing function so that the user of international prepaid phone cards can easily, rapidly, and accurately perform the dialing process of international phone calls.

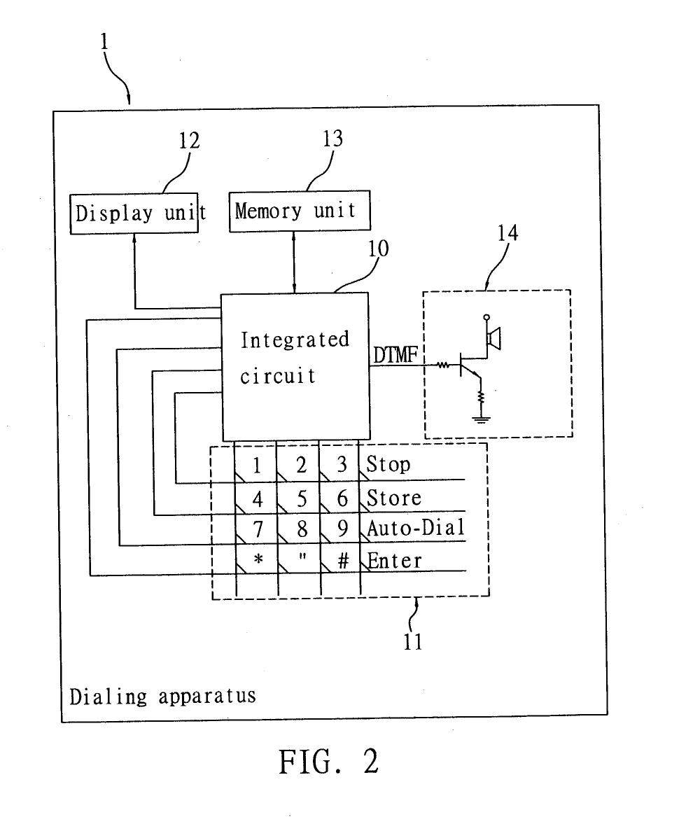

In FIG. 2, it shows the block diagram of the basic structure of the dialing apparatus for international prepaid phone cards 1. In the drawing, the dialing apparatus 1 includes an integrated circuit 10, a keyboard unit 11, a memory unit 12, a display unit 13 and a speaker 14.

According to the signal from the keyboard unit 11, the integrated circuit 10 performs a read-and-write operation and controls the display unit 13 and the speaker 14 to perform the corresponding actions. The integrated circuit, for example, a [symbol] (also called MPR, Microcontroller), is the control kernel of the present invention of a dialing apparatus 1, in which the units of ROM, RAM, CPR and I/O (all not shown) are integrated. Also, the memory unit 12 can be constructed in the RAM of the integrated circuit 10. The integrated circuit 10 supports the function of processing DTMF sound signals, which evolves the translation method of the original pulse signal to the tone signal. It not only enhanced the speed of translation, but also increased the reliability and the ability of anti-noise.

The keyboard unit 11, connected with the integrated circuit 10, which includes at least the number keys from 0 to 9 and the function keys “stop”, “store”, “auto-dial”, and “enter”, provides the user a mean to enter the configuration information of the used international prepaid phone cards and the plurality sets of the international phone numbers that the user wishes to call. The configuration information and the information of the international phone numbers are stored in the memory unit 12 of the integrated circuit. The display unit 13 also shows the information and the international phone numbers entered by the user from the keyboard unit 11 while configuring the apparatus so that the user is prompted whether the numbers are correct or not.

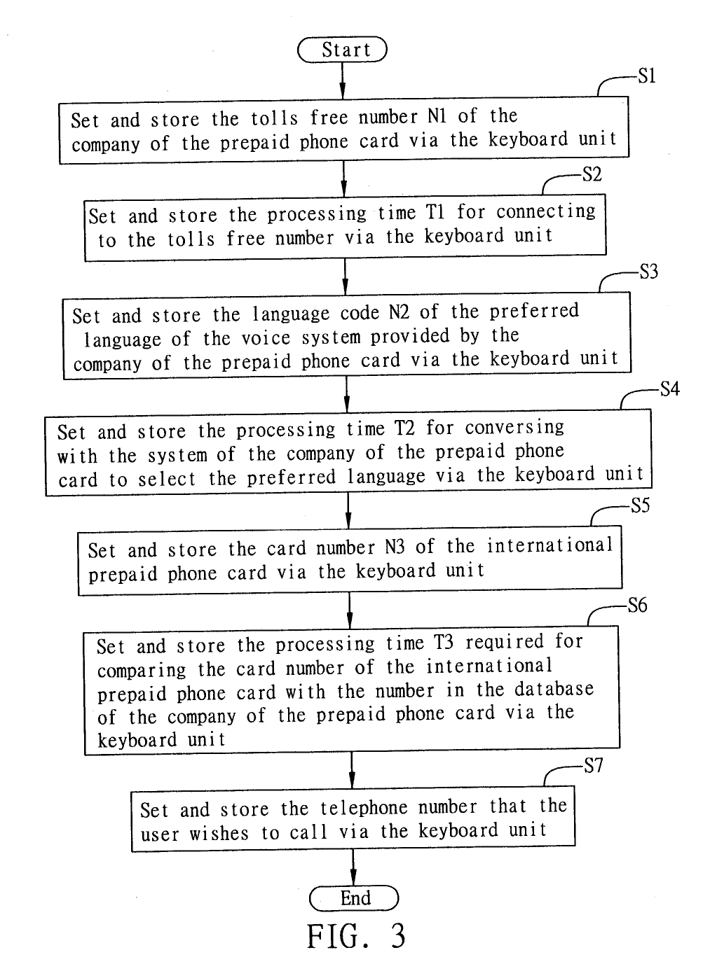

When the user wishes to place an international phone call, it is only necessary to press the “auto-dial” function key on the keyboard unit 11, then press the number keys corresponding to the telephone number that wishes to call. Based on the pre-stored basic information of the international prepaid phone cards and the very international telephone number that the user wishes to call, the present invention of a dialing apparatus 1 produces a corresponding DTMF signal and translate the DTMF signal to dial tone signal through the speaker 14 so that the telephone apparatus 20 of the local user can easily, rapidly and accurately perform the dialing process of international phone calls according to the dial tone signal received from the speaker of the dialing apparatus 1. The related configuration flow of entering the necessary information of the international prepaid phone cards and the international telephone numbers that the user wishes to call is disclosed in the following FIG. 3.

FIG. 3 is a flow diagram, which shows the configuration process of entering necessary data into the dialing apparatus 1 while the user uses the present invention of a dialing apparatus 1 for international prepaid phone cards for the first time. First, perform step S1, the user sets and stores the tolls free number of the company of the prepaid phone card N1 via keyboard unit 11, the process of which includes entering the tolls free number of the company of the prepaid phone card N1 by pressing the number keys from “0” to “9” via the keyboard unit 11, the corresponding number is also displayed simultaneously on the display unit 13 while each number key is pressed, next, sequentially enter the “store” function key, the “1” number key, and the “enter” function key, so that the integrated circuit 10 can store the tolls free number of the company of the prepaid phone card N1, entered by the user, into the memory unit 12, and set that tolls free number N1 as the first data item, and then proceed to step S2.

In step S2, the user sets and stores the required processing time T1 for the telephone switch 21 to connect the tolls free number N1, the process of which includes pressing the “stop” function key on the keyboard unit 11, wherein pressing once means to stop for 1 second, and pressing twice means to stop for 2 seconds, etc, the total amount of times the “stop” function key is pressed is also displayed on the display unit 13, which represents the processing time T1, next, the integrated circuit 10 stores the total number of times the “stop” function key is pressed (i.e. the process time T1) into the memory unit 12, and proceed to step S3.

In step S3, the user sets and stores the language code N2 corresponding to one of the languages of the voice system provided by the company of the prepaid phone card that the user prefers to use via keyboard unit 11, the process of which includes entering the language code N2 of the selected language by pressing the number keys from “0” to “9” on the keyboard unit 11, the corresponding number is also displayed simultaneously on the display unit 13 while the number key of the code is pressed, next, sequentially enter the “store” function key, the “2” number key and the “enter” function key provided by the keyboard unit 11, so that the integrated circuit 10 can store the language code N2 corresponding to one of the languages of the voice system provided by the company of the prepaid phone card into memory unit 12, and store the language code N2 as the second data item, and proceed to step S4.

In step S4, the user sets and stores and amount of time T2 that is required for conversing with the system of the company of the prepaid phone card while selecting a language via the keyboard unit 11, the process of which includes pressing the “stop” function key on the keyboard unit 11, wherein pressing once means to stop for 1 second, and pressing twice means to stop for 2 seconds, etc, the total amount of times the “stop” function key is pressed is also displayed on the display unit 13, which represents the processing time T2, next, the integrated circuit 10 stores the total number of times the “stop” function key is pressed (i.e. the process time T2) into the memory unit 12, and proceed to step S5.

In step S5, the user sets and stores the card number N3 of the international prepaid phone card that is used via keyboard unit 11, the process of which includes entering the card number N3 of the international prepaid phone card by pressing the number keys from “0” to “9” on the keyboard unit 11, the corresponding card number is also displayed simultaneously on the display unit 13 while the number keys are pressed, next, sequentially enter the “store” function key, the “3” number key and the “enter” function key provided by the keyboard unit 11, so that the integrated circuit 10 can store the card number of the international prepaid phone card N3 into memory unit 12, and store the card number N3 as the third data item, and proceed to step S6.

In step S6, the user sets and stores and amount of time T3 that is required for comparing the entered card number of the prepaid phone card with the number stored in the database of the company of the prepaid phone card via the keyboard unit 11, the process of which includes pressing the “stop” function key on the keyboard unit 11, wherein pressing once means to stop for 1 second, and pressing twice means to stop for 2 seconds, etc, the total amount of times the “stop” function key is pressed is also displayed on the display unit 13, which represents the processing time T3, next, the integrated circuit 10 stores the total number of times the “stop” function key is pressed (i.e. the process time T3) into the memory unit 12, and proceed to step S7.

In step S7, the user sets and stores the international phone number N4 that the user wishes to call via keyboard unit 11, the process of which includes entering the international phone number N4 that the user wishes to call by pressing the number keys from “0” to “9” on the keyboard unit 11, the international phone number is also displayed simultaneously on the display unit 13 while the corresponding number keys are pressed, next, sequentially enter the “store” function key, the “4” number key and the “enter” function key provided by the keyboard unit 11, so that the integrated circuit 10 can store the international phone number N4 into memory unit 12, and store the international phone number N4 as the fourth data item, and completes the initial configuration process.

After the initial configuration process is completed, one can perform step S7 described above if the user wishes to add another set of international phone number into the system. The process of such an addition includes entering the international phone number N5 by pressing the number keys from “0” to “9” on the keyboard unit 11, the international phone number is also displayed simultaneously on the display unit 13 while the corresponding number keys are pressed, next, sequentially enter the “store” function key, the “5” number key and the “enter” function key provided by the keyboard unit 11, so that the integrated circuit 10 can store the international phone number N5 into memory unit 12, and store the international phone number N5 as the fifth data item. Therefore, the newly added international phone numbers start from the fifth data item.

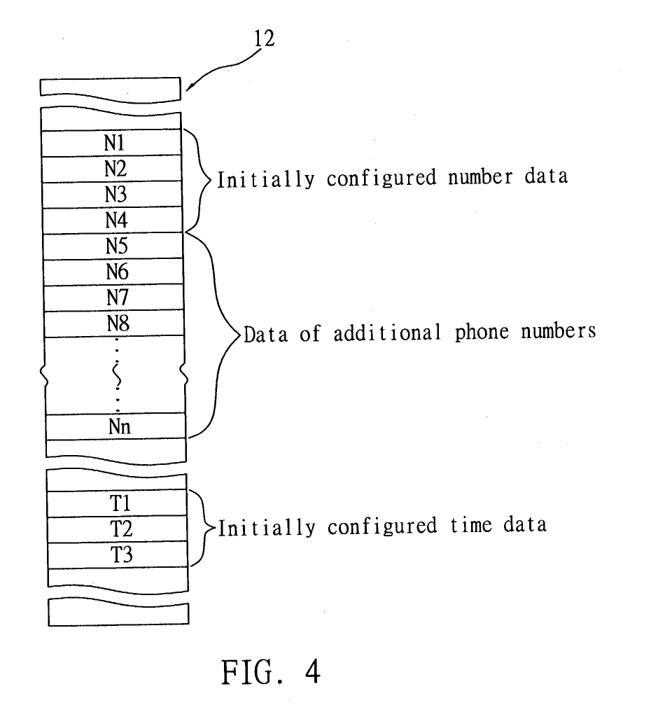

In FIG. 4, it shows the data stored in the memory unit 12 of the present invention of a dialing apparatus for the international prepaid phone cards. Based on the steps for entering the basic configuration information and the steps for adding plurality of international phone numbers illustrated in FIG. 3, the information stored in the memory unit 12 includes: the number information of the tolls free number N1 of the company of the prepaid phone card, the language code N2 corresponding to one of the languages of the voice system provided by the company of the prepaid phone card, the card number N3 of the international prepaid phone card that is used, and the initially configured international phone number N4 that the user wishes to call; the time information of the processing (stop) time T1 for connecting the tolls free number N1 of the company of the prepaid phone card, the processing (stop) time T2 for conversing with the system of the company of the prepaid phone card while selecting a preferred language, and the processing (stop) time T3 for comparing the card number of the prepaid phone card with the number stored in the database of the company of the prepaid phone card; and the plurality of the additional phone numbers (N5, N6, . . . , Nn).

After the initial configuration or the addition of an international phone number is completed, the user can dial any of the international phone number pre-stored in the memory unit 12 by pressing only three keys, the sequential process of which includes: press the “auto dial” function key on the keyboard unit 11, press the number key from “0” to “9” on the keyboard unit 11 that corresponds to the international phone number the user wishes to call (e.g. number key “4” corresponds to the first set of international phone number N4, number key “5” corresponds to the second set of international phone number N5, etc.), and press the “enter” function key on the keyboard unit 11. Next, the integrate circuit 10 will read sequentially the tolls free number N1 of the company of the prepaid phone card, the required processing (stop) time T1 for connecting the tolls free number N1, the language code N2, the required processing (stop time) T2 for conversing with the system of the company of the prepaid phone card while selecting a preferred language, the card number N3 of the international prepaid phone card, the required processing (stop) time T3 for comparing the card number of the international prepaid phone card with the number stored in the database of the company of the prepaid phone card and the first set of international phone number that the user wishes to call pre-stored in the memory unit 12, and generate the corresponding voice signal based on the number and time information by means of the DTMF signal processing function and transmit the voice signal to the speaker 14. The transmitter of the local telephone apparatus 20 (not shown) can thus receive the voice signal generated from the speaker 14, so that the telephone switch 21 can automatically execute the dialing procedure for international phone calls based on the received continuous voice signals.

In summary, the present invention of a dialing apparatus 1 for international prepaid phone cards stores the long string of tolls free number N1, language selection code, card number of the prepaid phone card and the plurality of international phone numbers in the memory unit 12, thus, according to the embodiments described above, the dialing process for international prepaid phone cards can be completed rapidly and accurately by simply pressing three keys. The processing (stop) time can also be inserted according to the data inputted. In addition, while the fare of the purchased international prepaid phone card has used up, there is no need to enter the long string of data or the plurality of phone numbers again, but to execute the configuration process of step S5 in FIG. 3, provided that the new prepaid phone card is purchased from the same company. On the contrary, it is only necessary to execute the configuration process of steps S1 to S6 but do not need to enter again the plurality of phone numbers provided that the prepaid phone card is purchased from a different company. Consequently, unlike the well known method of dialing international phone calls through the international prepaid phone cards, the present invention can simplify the input procedure to prevent the input error from happening and can avoid the inconvenience of inputting long strings of data. Therefore, the present invention of a dialing apparatus of the international prepaid phone cards is much more advanced and practical than the present art.

Moreover, the dialing function provided by the dialing apparatus 1 may also be integrated into a portable wireless communication device such as a mobile phone, a personal digital assistant (PDA), a pocket PC, or an IA device. One only needs to construct each of the units as described in FIG. 2 in the aforementioned wireless communication devices and the dialing procedure for placing international phone calls may thus be rapidly, conveniently and accurately completed.

The particular embodiments disclosed above are only the illustrations of the features and functions, but not limited to the applicable category, of the present invention. For example, the processing (stop) time (T1, T2, and T3) of the present invention can be configured not only by the user, but also automatically adjusted by the actual processing (waiting) time by the dialing apparatus 1. Furthermore, since the units of ROM, RAM, CPU and I/O (all not shown) can all be integrated into the integrated circuit 10, the memory unit 12 of the dialing apparatus 1 can be constructed in the integrated circuit 10. All the information in the memory unit 12 can be pre-stored in the RAM of the integrated circuit 10. Moreover, the completion of dialing an international phone call by simply pressing three keys of the present invention of a dialing apparatus 1 can also be realized by pressing other keys, it depends on each particular embodiment. Despite using an international prepaid phone card, the present invention may also be applied to placing long-distance and international phone calls by using a credit card. Besides, the principle and mechanism of dialing described above used for placing long-distance and international phone calls via both cellular phone and normal telephone apparatus is considered under the scope of the following claims. Therefore, it is evident that the particular embodiments disclosed above may be altered or modified and all such variations benefited from the present invention are considered with the scope and spirit of the invention covered under the following claims.

What is claimed is:

1. A dialing apparatus for an international prepaid phone card, for being applied to a telephone device to allow a user to make charged international phone calls through the use of the international prepaid phone card, the dialing apparatus comprising:
an integrated circuit;
a keyboard unit connected with the integrated circuit, for allowing the user to press keys of the keyboard unit to input information preset for using the international prepaid phone card and at least one phone number to be dialed, and for storing the information in a memory unit; and
a speaker connected with the integrated circuit;
wherein the integrated circuit reads the input information and phone number according to the keys of the keyboard unit pressed by the user, and produces a corresponding sound signal to the speaker which is urged to generate a dialing signal to the telephone device where dialing of the phone number is performed.

2. The dialing apparatus of claim 1, wherein the integrated circuit is a microcontroller compliant with processing DTMF (Dual Tone Multiple Frequency) signals in a manner that, the integrated circuit generates a DTMF signal in accordance with the pressed keys of the keyboard unit and transforms the DTMF signal to the dialing signal via the speaker to allow the telephone device to perform dialing of the phone number.

3. The dialing apparatus of claim 1, wherein the information preset for using the international prepaid phone card comprises a charge-free number of a provider for the prepaid phone card, a selected language code, and a card number of the international prepaid phone card.

4. The dialing apparatus of claim 3, wherein the memory unit further stores information of default stop-time values for performing dialing of the phone number in connection with the international prepaid phone card.

5. The dialing apparatus of claim 4, wherein the default stop-time values comprise a stop time for connecting the telephone device of the user to the charge-free number of the phone-card provider, a stop time for performing language selection according to the selected language code input from the user, and a stop time for identifying the card number of the international prepaid phone card input from the user.

6. The dialing apparatus of claim 5, wherein the default stop-time values are set by the user via the keyboard unit and stored in the memory unit.

7. The dialing apparatus of claim 5, wherein the default stop-time values are determined by the integrated circuit according to multiple performances of phone-number dialing and stored in the memory unit.

8. The dialing apparatus of claim 3, wherein the charge-free number of the phone-card provider, the selected language code, the card number of the international prepaid phone card, and the phone number to be dialed that are stored in the memory unit are each provided with a unique identification code.

9. The dialing apparatus of claim 2, wherein the integrated circuit comprises a ROM (read-only memory), RAM (random access memory), CPU (central processing unit), and I/O (input/output) unit.

10. The dialing apparatus of claim 1, further comprising: a display unit for displaying data input from the user through the use of the dialing apparatus.

11. The dialing apparatus of claim 1, wherein the dialing apparatus may be one of the mobile phone and the wireless communication devices.

12. The dialing apparatus of claim 12, wherein the wireless communication apparatus may be a personal digital assistant (PDA).
